(19) United States
(12) Patent Application Publication
(10) Pub. No.: US 2004/0024831 A1
(43) Pub. Date: Feb. 5, 2004

(54) Blade server management system

(76) Inventors: Shih-Yun Yang, Taoyuan Hsien (TW); Ching-Chih Shih, Taoyuan Hsien (TW); Chin-Tsai Yen, Taipei Hsien (TW); Yu-Cheng Chen, Kaoshiung Hsien (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/281,447

(22) Filed: Oct. 25, 2002

(30) Foreign Application Priority Data
Jun. 28, 2002 (TW) 91114454

(51) Int. Cl. G06F 15/16; G06F 15/173

(52) U.S. Cl. 709/208; 709/223

(57) ABSTRACT

A management system of blade server is described. The system comprises at least two management blades and a middle interface. The two management blades become one master management blade to control directly the system and a slave management blade prepared to control the system when the system is turned on. The middle interface installs server blades, switch blades and the management blades thereon according to the actual request. A COM port is a main interconnecting line between the management blades and a LAN port is an auxiliary interconnecting line. The system can directly exchange the master management blade and the slave management blades by way of application software. The slave management blade is promoted to master management blade immediately when the original master management blade fails to work.

### FIELD OF THE INVENTION

The present invention relates to a blade server management system and especially to a blade server management system with an assisting management blade.

### BACKGROUND OF THE INVENTION

Information technology and the computer industry are highly developed now. People rely heavily on computer systems. Therefore, computer servers with higher calculation capacity and higher stability are important for computer systems. Due to increasingly reduced office space, area occupied by a computer server must also be reduced. Traditional computer servers must maintain a high degree of stability to serve users, and the space occupied by one computer server is therefore greater than or equal to that of a desktop computer. The management of computer servers is difficult and the space utilization is tightened. Some normal companies have 2 or 3 computer servers and others may have more than a thousand computer servers. Computer server management and space utilization become more critical in companies with more computer servers.

A blade server is a trend in computer servers. The blade server combines the hardware of the computer server, such as a processor, a memory and a network connection, in one extension card, also known as one server blade. The blade server has a higher calculation capacity and higher stability, and moreover occupies less space compared with a traditional computer server. Further, the blade server reduces the cost and the working temperature; moreover many functions and performance thereof are better than in traditional computer servers. The blades of the blade server, called a server blade, are inserted in an interface board in a server casing. Therefore, after the user buys the required server blades and inserts the server blades in the interface board, new servers can work immediately. Each server blade works independently from other server blades. When the user needs more servers, the user needs only to insert additional server blades into the interface board in the casing. Therefore, a plurality of blade servers may work in only one casing similar in size to one conventional server.

The blade servers are high speed and stable computer server equipment for users having many servers such as a telecommunication company, Internet portal company, or internet services provider (ISP), and users needing great quantities of high speed calculations such as meteorological phenomena calculations, astronomical observations and calculations, deoxyribonucleic acid calculations in bioscience, and computer animation for the movie industry.

There are two types of blade server managements. One is an in-band management and one is an out-band management. For the in-band management, the management software is based on a basic input/output system (BIOS) or an operating system (OS). The in-band management utilizes software to control blade servers without any management blade. Therefore, if any one blade server crashes, the server manager may lose the blade server. For the out-band management, there is a management blade control the blade servers. If any server blade is functioning in an unusual manner, the management blade reports to the server manager and then the server manager immediately repairs the unusual phenomenon according to the report. But if the management blade crashes, the out-band management degenerates to the in-band management. Moreover, if any blade server crashes, the server manager still loses the blade server and fails to control and repair the blade server immediately.

### SUMMARY OF THE INVENTION

There is a need to provide a blade server management system that assists the management blade immediately when the management blade crashes so that the server manager can always control the blade servers and repair the crashed blade servers, enhancing the overall stability of the blade servers. One object of the present invention is therefore to provide a blade server management system with an assisting management blade to enhance the stability of the management of the blade servers.

Another object of the present invention is to provide a blade server management system with an assisting management blade where the server manager can replace the management blades and change the main management blade and the assisting management blade directly while they are working.

The present invention provides a blade server management system to control server blades and switch blades. The management system comprises at least two management blades and a middle interface. The two management blades form a master management blade and at least one slave management blade when the management system is turned on. The master management blade controls the server blades and the switch blades directly. The slave management blade gets information from the master management blade to prepare instead of the master management blade. The middle interface is a hardware unit and electrically couples with the management blades, the server blades, and the switch blades according to actual requests. The master management blade directly controls the server blades and the switch blades by way of the middle interface.

Further, the master management blade and the slave management blade transfer to each other and keep the information synchronization by way of communication ports. When the communication ports fail to connect, the master management blade and the slave management blade transfer and maintain information synchronization therebetween by way of local area network ports. The management blades send out heart beat signals to each other and the first management blade that successfully transmits the heart beat signals to the other management blades is the master management blade. The other management blades that receive the heart beat signals from the master management blade are the slave management blades.

Furthermore, the master management blade and the slave management blades change according to an application software request, and then the master management blade becomes the slave management blade while one of the slave management blades becomes the master management blade. The master management blade and the slave management blade are separated by hardware isolations to keep the slave management blades from controlling the server blades and the switch blades directly. The slave management blade replaces the master management blade as a new master management blade and sends out the information and the heart beat signals to update the information of the management system when the master management blade fails to work and then the management system is immediately controlled by the new master management blade.

Therefore, the present invention increases the stability of the blade servers. The server manager can control the servers more efficiently and get information regarding these servers working status immediately.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 schematically illustrates one preferred embodiment of the blade server management system according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

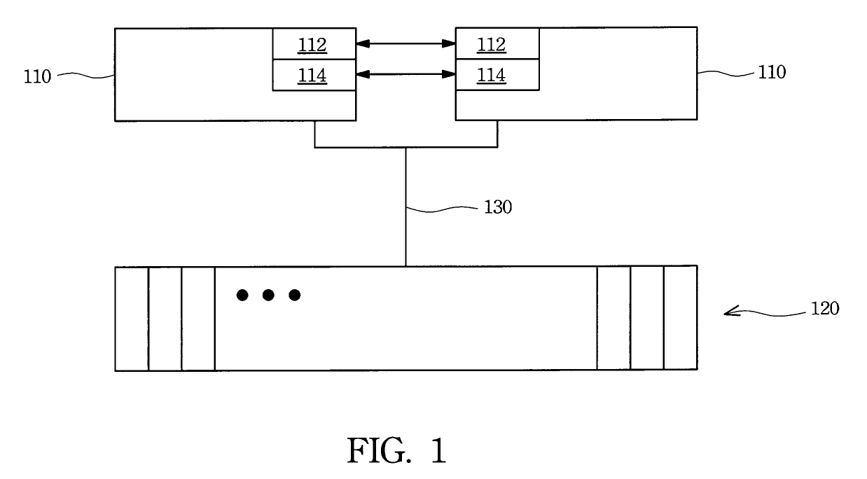

FIG. 1 is one preferred embodiment of the blade server management system according to the present invention. The blade server management system according to the present invention comprises at least two management blades 110 and a middle interface 130. The blade server management system controls a plurality of server blades and switch blades 120. Two management blades 110 communicate with each other by way of communication (COM) ports 112 and local area network (LAN) port 114.

The management system utilizes at least two management blades 110 to control all server blades and switch blades 120 in one server casing. The quantity of server blades and switch blades 120 can be determined by the actual request. For example, if only two server blades and one switch blade are requested, the server manager has to insert the two server blades and one switch blade in the middle interface 130. Then, the management system according to the present invention can control and manage these server blades and the switch blade. The server blade functions as a server in a network. The switch blade functions as a network signals exchange.

The management blades 110 use a free competition rule to determine a master management blade and a slave management blade when the system turns on. Each management blade has the function of sending heart beat signals out, and the first management blade to send out the heart beat signals to the other management blade becomes the master management blade and has the control authority. Therefore, the other management blade receiving the heart beat signals from the master management blade automatically becomes a slave management blade. Hence, the two management blades 110 form one master management blade and one slave management blade. With a hardware separation design, the slave management blade does not control the server blades and the switch blades. The slave management blade only gets the information from the master management blade by way of COM ports 112. The information includes media access control (MAC) address and a chassis identification code. In this moment, the master management blade also gets the data from the slave management blade by way of the COM ports 112. The data include the field replacement unit (FRU) and the MAC address of the local area network. Because the slave management blade does not control the server blades and the switch blades, the management system is not in conflict and does not reduce the system efficiency. The slave management blade gets the information from the master management blade by way of the COM ports 112. Therefore, if the master management blade crashes or the server manager requests a change of the master management blade via an application software, the slave management blade immediately becomes the master management blade. Because the slave management blade cannot detect the heart beat signals from the master management blade, the slave management blade becomes a new master management blade and sends out new heart beat signals and information to update the relevant information of the management system. Therefore, the new master management blade controls the server blades, the switch blade, and the whole management system to avoid a management break and data lost.

Further, the slave and master information and data are guaranteed to be the same at the moment when the slave management blade is used instead of the master management blade. The management system according to the present invention not only use the COM ports 112 to transfer the data and information but also use the LAN ports 114 to form an auxiliary interconnecting line to transfer the data and information if the COM ports fail to connect to each other.

The present invention utilizes the hardware separation design to avoid a conflict between the slave management blade and the management system and utilizes the COM port and LAN port to connect the two management blades to maintain important data and information synchronization. Therefore, the slave management blade can prepare to take over the management system immediately to control the server blades and the switch blades without any management break. The server manager can replace the damaged management blade without influence of the normal operation condition. Moreover, the LAN ports assist the COM ports to maintain data and information synchronization. The management system can work more safely and is more stable. Hence, the server manager can control the computer servers with lower risk. The server manager can change the damaged management blades to keep the system working smoothly. The slave management blade and the LAN ports are prepared to take over the master blade and the COM port, at any time, respectively. Accordingly, a lower risk control of the computer server is achieved. The present invention is not limited to two management blades, and the user can determine the quantity of the management blades.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A blade server management system for controlling server blades and switch blades, the management system comprising:
two management blades including a master management blade and a slave management blade as the management system turning on, wherein the master management blade controls the server blades and the switch blades directly, and the slave management blade gets information from the master management blade to prepare instead of the master management blade; and
one middle interface electrically coupling with the management blades, the server blades, and the switch blades, the master management blade directly controlling the server blades and the switch blades by way of the middle interface.

2. The management system of claim 1, wherein the master management blade and the slave management blade transfer and keep the information synchronization to each other by way of communication ports.

3. The management system of claim 2, wherein the master management blade and the slave management blade transfer and keep the information synchronization to each other by way of local area network ports while the communication ports fail to connect.

4. The management system of claim 3, wherein the master management blade transfers a media access control (MAC) address and a chassis identification (chasis ID) to the slave management blade.

5. The management system of claim 3, wherein the slave management blade further transfers a field replacement unit and a media access control address to the master management blade.

6. The management system of claim 1, wherein the management blades send out heart beat signals to each other.

7. The management system of claim 6, wherein one of the management blades transmitting the heart beat signals to the other management blade firstly is the master management blade, and the other management blade receives the heart beat signals from the master management blade is the slave management blade.

8. The management system of claim 1, wherein the middle interface is a hardware to connect the management blades, the server blades and the switch blades and the management blades, the server blades and the switch blades insert on the middle interface according to actually requirements.

9. The management system of claim 1, wherein the master management blade and the slave management blade change each other according to an application software request, and the master management blade becomes the slave management blade and the slave management blade becomes the master management blade.

10. The management system of claim 1, wherein the master management blade and the slave management blade are separated by hardware isolations to keep the slave management blade out of controlling the server blades and the switch blades directly.

11. The management system of claim 1, wherein the slave management blade replaces the master management blade to be a new master management blade and sends out the information and heart beat signals to update the information of the management system while the master management blade fails to work and then the management system is controlled by the new master management blade immediately.

12. A blade server management system comprising:
at least one server blade providing computer server functions;
at least one switch blade providing network signal switch functions;
at least two management blades forming a master management blade and slave management blade when the management system is turned on, wherein the master management blade controls the server blades and the switch blades directly, and the slave management blades get information from the master management blade to prepare instead of the master management blade; and
one middle interface electrically coupling with the management blades, the server blades, and the switch blades, wherein the master management blade directly controls the server blades and the switch blades by way of the middle interface.

13. The management system of claim 12, wherein the master management blade and the slave management blades transfer and maintain information synchronization therebetween by way of communication ports.

14. The management system of claim 13, wherein the master management blade and the slave management blades transfer and maintain information synchronization therebetween by way of local area network ports while the communication ports fail to connect.

15. The management system of claim 14, wherein the master management blade transfers a media access control address and a chassis identification to the slave management blades.

16. The management system of claim 14, wherein the slave management blades further transfer field replacement units and media access control addresses to the master management blade.

17. The management system of claim 12, wherein the management blades send out heart beat signals to each other and a first management blade to transmit successfully the heart beat signals to other management blades is the master management blade, while the other management blades receiving the heart beat signals from the master management blade are the slave management blades.

18. The management system of claim 12, wherein the master management blade and the slave management blades change according to an application software request, and the master management blade becomes the slave management blade and one of the slave management blade becomes the master management blade.

19. The management system of claim 12, wherein the master management blade and the slave management blades are separated by hardware isolations to keep the slave management blades from controlling the server blades and the switch blades directly.

20. The management system of claim 12, wherein one of the slave management blades replaces the master management blade to be a new master management blade and sends out information heart beat signals to update the information of the management system when the master management blade fails to work and the management system is then immediately controlled by a new master management blade.
